(19) United States
(12) Patent Application Publication
(10) Pub. No.: US 2026/0279961 A1
(43) Pub. Date: Sep. 17, 2026

(54) BATTERY MODULE

(71) Applicant: Panasonic Intellectual Property Management Co., Ltd., Osaka (JP)

(72) Inventors: Yusuke OKII, Osaka (JP); Keita YAMAUCHI, Osaka (JP); Yosuke SAWA, Hyogo (JP); Motomasa INUI, Osaka (JP)

(21) Appl. No.: 19/325,014

(22) Filed: Sep. 10, 2025

Related U.S. Application Data
(63) Continuation of application No. PCT/JP2025/019976, filed on Jun. 3, 2025.

(30) Foreign Application Priority Data
Mar. 13, 2025 (JP) 2025-040430

(51) Int. Cl. H01M 10/6563; H01M 10/42; H01M 10/613; H01M 50/358

(52) U.S. Cl. CPC H01M 10/6563; H01M 10/4228; H01M 10/613; H01M 50/358

(57) ABSTRACT

A battery module comprising: an exterior case; a battery assembly accommodated in the exterior case; an inflow port provided in an end wall of the exterior case; a fan that is attached to an inner surface of the end wall and blows air suctioned through the inflow port to an inside of the exterior case; an upright wall portion that is disposed between the battery assembly and the fan, and has an opposing surface facing the fan; and a liquid leakage sensor disposed below the opposing surface.

### CROSS REFERENCE TO RELATED APPLICATION

This is a continuation application claiming priority of International Patent Application No. PCT/JP2025/019976 with an international filing date of June 3, 2025, which claims priority of Japanese Patent Application No. 2025-040430 filed on March 13, 2025, the entire contents of which are incorporated herein by reference.

### BACKGROUND

### Technical Field

The present disclosure relates to a battery module.

### Background Art

WO 2018/123573 A1 discloses a battery module in which a plurality of battery cells are housed in a case. The battery module includes a fan for air-cooling a heat generating component such as a battery cell. The case is provided with an inlet and an outlet through which cooling air passes, and the inlet and the outlet are configured by a plurality of through holes.

### SUMMARY

As an example of a use form of the battery module, one or more battery modules may be aligned on a shelf together with a water-cooled electronic device. If the coolant leaks, the coolant may enter the case of the battery module through an inlet or an outlet for cooling air. In other use forms, there is also a risk of liquid entry.

An object of the present disclosure is to provide a battery module capable of accurately detecting entry of liquid.

One aspect of the present disclosure provides a battery module comprising: an exterior case; a battery assembly accommodated in the exterior case; an inflow port provided in an end wall of the exterior case; a fan that is attached to an inner surface of the end wall and blows air suctioned through the inflow port to an inside of the exterior case; an upright wall portion that is disposed between the battery assembly and the fan, and has an opposing surface facing the fan; and a liquid leakage sensor disposed below the opposing surface.

According to the present disclosure, it is possible to provide a battery module capable of accurately detecting entry of liquid.

### BRIEF DESCRIPTION OF THE DRAWINGS

FIG. 1 is a perspective view of a battery module according to an embodiment.

FIG. 2 is a partial cross-sectional view of the battery module of FIG. 1.

FIG. 3 is an exploded perspective view of the battery module of FIG. 1.

FIG. 4 is a partially exploded perspective view of the battery module of FIG. 1.

FIG. 5 is an exploded perspective view as viewed from a side opposite to FIG. 4.

FIG. 6 is a partial plan view of the battery module of FIG. 1 in a state where a cover of an exterior case is removed.

FIG. 7 is an exploded perspective view of the exhaust duct, the sensor holder, and the liquid leakage sensor of FIG. 4.

FIG. 8 is a perspective view illustrating an assembled state of the exhaust duct, the sensor holder, and the liquid leakage sensor of FIG. 7 as viewed from a back surface side.

FIG. 9 is a perspective view illustrating an assembled state of the exhaust duct, the sensor holder, and the liquid leakage sensor of FIG. 7 as viewed from the front side.

FIG. 10 is a perspective view of the assembled state in FIG. 9 as viewed from the opposite side in the width direction.

FIG. 11 is a partial cross-sectional view of a battery module according to a first modification.

FIG. 12 is a partial cross-sectional view of a battery module according to a second modification.

### DETAILED DESCRIPTION

Hereinafter, embodiments of the present invention are described with reference to the drawings. Note that the same or corresponding elements are denoted by the same reference numerals throughout the drawings, and overlapping of detailed description will be omitted.

A battery module according to an embodiment of the present disclosure includes: an exterior case; a battery assembly accommodated in the exterior case; an inflow port provided in an end wall of the exterior case; a fan that is attached to an inner surface of the end wall and blows air suctioned through the inflow port to an inside of the exterior case; an upright wall portion that is disposed between the battery assembly and the fan, and has an opposing surface facing the fan; and a liquid leakage sensor disposed below the opposing surface.

According to the above configuration, the heat generating component such as the battery assembly can be cooled by the air blown out from the fan. On the other hand, there is a possibility that liquid is carried by the air flow formed by the fan to enter the inside of the exterior case from the outside of the exterior case through the inflow port. The fan faces the opposing surface of the upright wall portion.

Here, when the air volume of the fan is large, the liquid suctioned into the fan is strongly blown out together with air from the fan, strongly blown toward the opposing surface, and adheres as droplets onto the opposing surface. The droplet flows downward along the opposing surface by its own weight while taking in the liquid adhering to the opposing surface at the lower side and increasing the size thereof. The liquid leakage sensor is disposed below such an opposing surface. Therefore, the liquid leakage sensor can favorably sense a droplet flowing down on the opposing surface.

When the air volume of the fan is small, the liquid suctioned into the fan descends by its own weight while flying in the airflow direction. Therefore, there is a possibility that the liquid does not adhere to the opposing surface as described above. However, since the liquid leakage sensor is disposed below the opposing surface, the liquid blown out from the fan is directly blown to the liquid leakage sensor, and it is possible to favorably sense the entry of the liquid.

As described above, it is possible to provide a battery module capable of accurately detecting entry of liquid regardless of the air volume of the fan.

The liquid leakage sensor may be disposed below the fan.

The above configuration, when the air volume of the fan is small, facilitates direct adhesion of the liquid flying while descending from the fan to the liquid leakage sensor.

In the electric module according to another embodiment of the present disclosure, the lower end portion of the upright wall portion may be inclined so as to be spaced apart from the fan toward the lower side.

According to the above configuration, the droplets on the opposing surface flow away from the fan along the inclination at the lower end of the upright wall portion and fall from the tip of the inclination. It is possible to drop the liquid collected on the opposing surface to the liquid leakage sensor while securing a distance between the liquid leakage sensor and the fan. It is possible to achieve both securing a space for disposing the liquid leakage sensor and improving detection accuracy of liquid entry.

In the electric module according to another embodiment of the present disclosure, the upright wall portion may have a V shape inclined so as to be spaced apart from the fan from the center toward both outer sides in the width direction in plan view.

According to the above configuration, air can be guided in a direction away from the fan while enabling the upright wall portion to receive liquid. It is possible to achieve both improvement in detection accuracy of liquid entry and improvement in air cooling performance.

An electric module according to another embodiment of the present disclosure may further include an exhaust duct that forms an exhaust path for guiding gas released from the battery assembly, and the exhaust duct may have the upright wall portion.

According to the above configuration, the exhaust duct having the function of guiding the gas also has the function of receiving the liquid. The number of components of the battery module can be reduced, and the peripheral structure of the liquid leakage sensor becomes compact.

In an electric module according to another embodiment of the present disclosure, the exhaust path may guide the gas from a space on the battery assembly side with respect to the upright wall portion to a space on the fan side with respect to the upright wall portion through an outlet below a lower edge of the upright wall portion while meandering, and the liquid leakage sensor may be disposed at the outlet.

According to the above configuration, since the release path has a labyrinth shape, the temperature of the gas can be lowered until the gas is released to the outside of the exterior case. The liquid leakage sensor is disposed utilizing an opening portion for forming the labyrinth. Compared to a case where a dedicated space for disposing the liquid leakage sensor is secured, a peripheral structure of the liquid leakage sensor becomes compact.

The electric module according to another embodiment of the present disclosure may further include a sensor holder that is disposed between the battery assembly and the fan and holds the liquid leakage sensor.

According to the above configuration, positioning and assembly of the liquid leakage sensor are facilitated by providing a dedicated component for holding the sensor.

Hereinafter, specific examples of the present disclosure will be described in detail with reference to the drawings. In the following description, terms (for example, “upper”, “lower”, and other terms including those terms.) indicating specific directions and positions are used as necessary, but the use of these terms is to facilitate understanding of the present disclosure with reference to the drawings, and the technical scope of the present disclosure is not limited by the meanings of these terms. Parts denoted by the same reference numerals in a plurality of drawings indicate the same or equivalent parts or members. Furthermore, the following embodiments illustrate specific examples of the technical idea of the present disclosure, and do not limit the present disclosure to the following. In addition, dimensions, materials, shapes, relative arrangements, and the like of the components described below are not intended to limit the scope of the present disclosure only to the dimensions, materials, shapes, relative arrangements, and the like unless otherwise specified, and are intended to be illustrative. The contents described in one embodiment and example are also applicable to other embodiments and examples. The sizes, positional relationships, and the like of the members illustrated in the drawings may be exaggerated for clarity of description.

The battery module of the present disclosure is applied to, for example, an emergency power supply such as a battery backup unit (BBU). However, the present disclosure does not specify the application of the battery module, and can be used as a power source for various other electric devices such as a power source of a traveling motor of a vehicle.

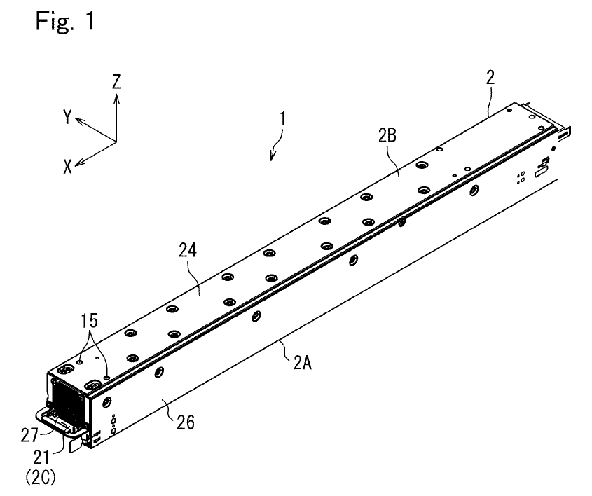

Referring to FIGS. 1 to 3, a battery module 1 according to the present embodiment includes an exterior case 2, a battery assembly 3, a fan 5, an upright wall portion 6, and a liquid leakage sensor 7. The battery module 1 further includes a first circuit unit 4A, a second circuit unit 4B, an exhaust duct 8, and a sensor holder 9.

The exterior case 2 has a rectangular parallelepiped shape, and has a rectangular shape as viewed in the height direction Z (that is, in plan view). In the following description, an extending direction of the long side of the rectangle is referred to as a longitudinal direction X, and an extending direction of the short side is referred to as a width direction Y. The longitudinal direction X, the width direction Y, and the height direction Z are orthogonal to the other two directions.

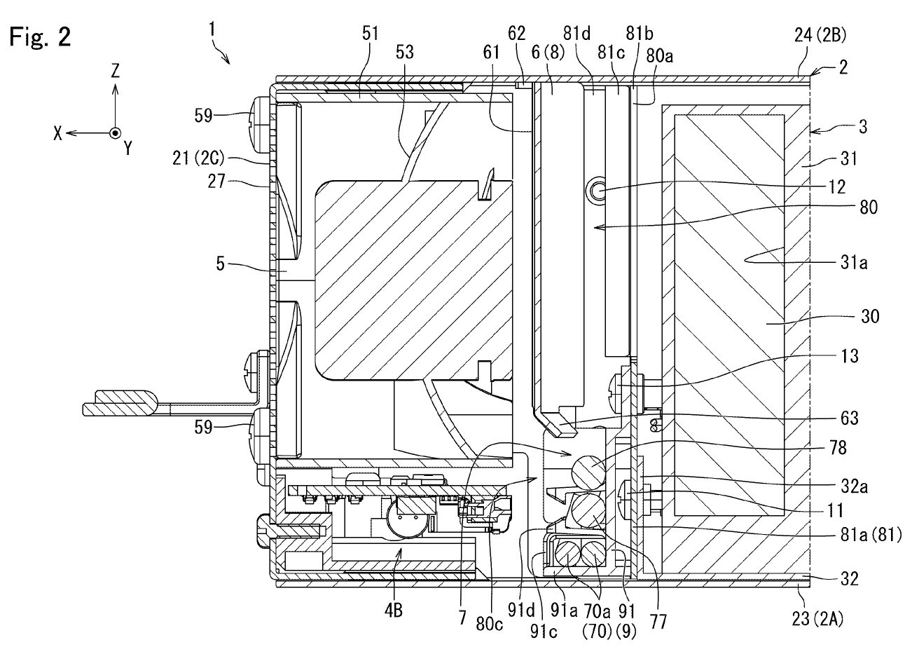

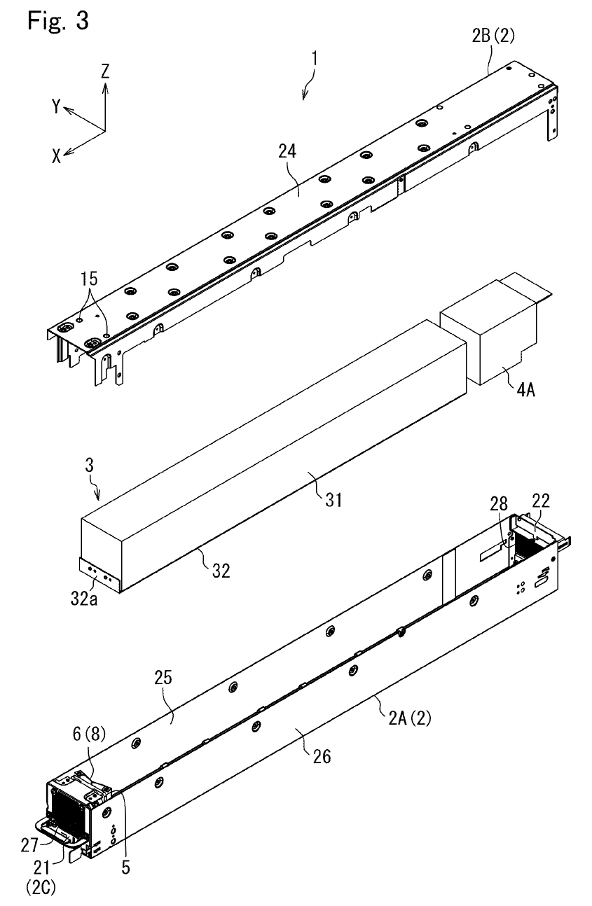

The exterior case 2 includes a first end wall 21 and a second end wall 22 facing each other in the longitudinal direction X, a bottom wall 23 and a top wall 24 facing each other in the height direction Z, and a first side wall 25 and a second side wall 26 facing each other in the width direction Y. The exterior case 2 defines an internal space surrounded by these walls. The first end wall 21 extends upward from the end of the bottom wall 23 on one sidein the longitudinal direction X (lower left side of FIGS. 1 and 3, left side of FIG. 2) and is connected to the end of the top wall 24. The second end wall 22 connects the ends of the bottom wall 23 and the top wall 24 to each other on the other side in the longitudinal direction X (upper right side in FIGS. 1 and 3). The first side wall 25 connects the first end wall 21 and the second end wall 22 on one side in the width direction Y (upper left side in FIGS. 1 and 3). The second side wall 26 connects the first end wall 21 and the second end wall 22 on the other side in the width direction Y (lower right side in FIGS. 1 and 3).

The exterior case 2 has an inflow port 27 provided in the first end wall 21 and an outflow port 28 provided in the second end wall 22. Both the inflow port 27 and the outflow port 28 are formed of a plurality of through holes, and allow the inside and the outside of the exterior case 2 to communicate with each other and air for air-cooling electric components in the exterior case 2 to pass therethrough.

The exterior case 2 includes a base 2A and a cover 2B that can be separated in the height direction Z as components thereof. The base 2A constitutes at least the bottom wall 23, and also constitutes the first side wall 25 and the second side wall 26 in this example. The cover 2B constitutes at least the top wall 24. In the present embodiment, the exterior case 2 further includes an end plate 2C constituting the first end wall 21 as a component thereof. However, the component division of the exterior case 2 can be appropriately changed. The second end wall 22 may be integrated with the base 2A, may be integrated with the cover 2B, or may be configured by components separate from the base 2A and the cover 2B.

Inside the exterior case 2, the fan 5, the liquid leakage sensor 7, the exhaust duct 8, the battery assembly 3, and the first circuit unit 4A are housed in this order from one side to the other side in the longitudinal direction X. The liquid leakage sensor 7 is held by the sensor holder 9 and is located below the upright wall portion 6. The upright wall portion 6 is disposed between the fan 5 and the battery assembly 3, and constitutes a part of the exhaust duct 8.

The battery assembly 3 includes a plurality of battery cells 30 (only one is shown in FIG. 2) and a cell holder 31 that holds the plurality of battery cells 30 in place. For example, the battery cell 30 is a non-aqueous electrolyte secondary battery such as a lithium ion battery, and has a cylindrical container. However, the battery cell 30 may be, for example, a battery other than a cylindrical type such as a square type, or may be, for example, a battery other than a lithium ion battery such as an all-solid battery.

The cell holder 31 has a substantially rectangular parallelepiped shape as a whole. Although not illustrated in detail, the plurality of battery cells 30 are held in a vertical posture with the axial direction thereof oriented in the height direction Z. The cell holder 31 has a plurality of accommodating portions 31a that individually accommodate the plurality of battery cells 30. Each of the accommodating portions 31a has a cylindrical shape to house a corresponding battery cell.

The battery assembly 3 includes a current collection structure and a heat transfer structure (not shown). The current collection structure may have a lead plate made of a material having conductivity in order to electrically connect the battery cells 30 to each other. The heat transfer structure may have a sheet or plate made of a material having thermal conductivity in order to take heat from the battery cell 30. These structures are stacked on the top surface or the bottom surface of the cell holder 31, and constitute a block body together with the cell holder 31.

The battery assembly 3 has a support plate 32 that supports such a block body from below. The support plate 32 has a flat plate shape and is fixed to the bottom wall 23 of the exterior case 2. The support plate 32 has a turnover part 32a folded upward from one end in the longitudinal direction X. The block body is positioned on the other side in the longitudinal direction X with respect to the turnover part 32a.

The first circuit unit 4A is disposed between the battery assembly 3 and the second end wall 22. The second circuit unit 4B is housed in a space surrounded by the inner surface of the first end wall 21, the inner surface of the bottom wall 23, and the lower surface of the fan 5.

The first circuit unit 4A and the second circuit unit 4B may include a monitoring module for monitoring the state of the battery cell 30, a charge/discharge control module for controlling charge and discharge of the battery cell 30, a voltage conversion module for converting (for example, stepping down, stepping up, or both) a DC voltage transmitted from the battery cell 30 or to the battery cell 30, a fan control module for controlling the air volume of the fan 5 according to the state (for example, temperature) of the battery cell 30, and the like. Note that a part of the module exemplified here may be mounted on a substrate (not illustrated) disposed at another location (for example, a space between the battery assembly 3 and the first side wall 25 or the second side wall 26). When the liquid leakage sensor 7 detects entry of liquid, the charge/discharge control module and the voltage conversion module stop some or all of their functions.

The fan 5 is, for example, an axial fan. The fan 5 includes a fan frame 51 having a rounded square shape when viewed in the axial direction, four bolt insertion holes 52 provided at four corners of the fan frame 51, and an impeller 53 rotatably supported at the center of the fan frame 51. When the impeller 53 rotates, the fan 5 suctions air from the rear of the fan and blows the air toward the front of the fan.

The fan 5 is attached to the inner surface of the first end wall 21 and covers the first end wall 21(in particular, covers the upper half thereof from the inside). More specifically, the rear surface (suction-side end surface) of the fan 5 is directed toward the inner surface of the first end wall 21 so as to cover the inflow port 27. Four bolts 59 are inserted into the first end wall 21 from the outer surface side to the other side in the longitudinal direction X, inserted into the four bolt insertion holes 52, and screwed into the fan frame 51.

The fan 5 forms an airflow directed in the axial direction thereof. The axial direction of fan 5 corresponds to longitudinal direction X of battery module 1. The upstream side in the airflow direction corresponds to one side in the longitudinal direction X, and the downstream side corresponds to the other side in the longitudinal direction X. Air is suctioned into the fan 5 immediately after passing through the inflow port 27, and is blown out from the fan 5 into the exterior case 2. The air cools the battery assembly 3 and the first circuit unit 4A in the process of flowing toward the other side in the longitudinal direction X inside the exterior case 2. The air flows out to the outside of the exterior case 2 through the outflow port 28.

Here, during use of the battery module 1, an outer surface of the exterior case 2 may be wetted with liquid. As an example, one or more battery modules 1 may be aligned on a shelf with external electronics to serve as a BBU, and water cooling may be applied to cool the electronics. When the coolant leaks from the water-cooling system, the coolant may drip onto the outer surface of the top wall 24 of the exterior case 2. Examples of the coolant (that is, liquid that can adhere to the exterior case 2) include water, an ethylene glycol aqueous solution, and a propylene glycol aqueous solution.

Liquid (for example, water) that has wetted the outer surface of the exterior case 2 is drawn toward the first end wall 21 by the action of the fan 5, and can enter the inside of the exterior case 2 through the inflow port 27. The entering liquid sequentially passes through the inflow port 27, the fan rear surface, and the fan frame 51, and is carried by the air flow and blown out from the fan front surface.

The liquid leakage sensor 7 is, for example, a cord type or a rope type. The liquid leakage sensor 7 includes a long and flexible string-like, rope-like, or belt-like detection cord 70. When liquid (for example, water) touches the detection cord 70, the liquid penetrates the detection cord 70, and two electrode wires (not illustrated) in the detection cord 70 are short-circuited through the liquid. The liquid leakage sensor 7 electrically detects this short circuit to detect that liquid is present around the liquid leakage sensor 7. In a case where the liquid leakage sensor 7 is accommodated in the exterior case 2 in which liquid does not originally exist, the detection of the presence of liquid means detection of entry of liquid into the exterior case 2.

The rear surface of the fan 5 is in contact with the inner surface of the first end wall 21 or faces the inner surface of the first end wall 21 through a slight clearance. The space behind the fan can be compressed, which contributes to improvement of the volume energy density of the battery module 1. On the other hand, when the clearance between the rear surface of the fan and the first end wall 21 is clogged, there is no room for disposing the liquid leakage sensor 7 on the liquid entry path (for example, between the inflow port 27 and the fan rear surface). In order to enable the liquid leakage sensor 7 to detect the entry of liquid, it is required to dispose the liquid leakage sensor 7 in front of the fan in the exterior case 2 and to bring the liquid blown out by the airflow into contact with the liquid leakage sensor 7 as much as possible.

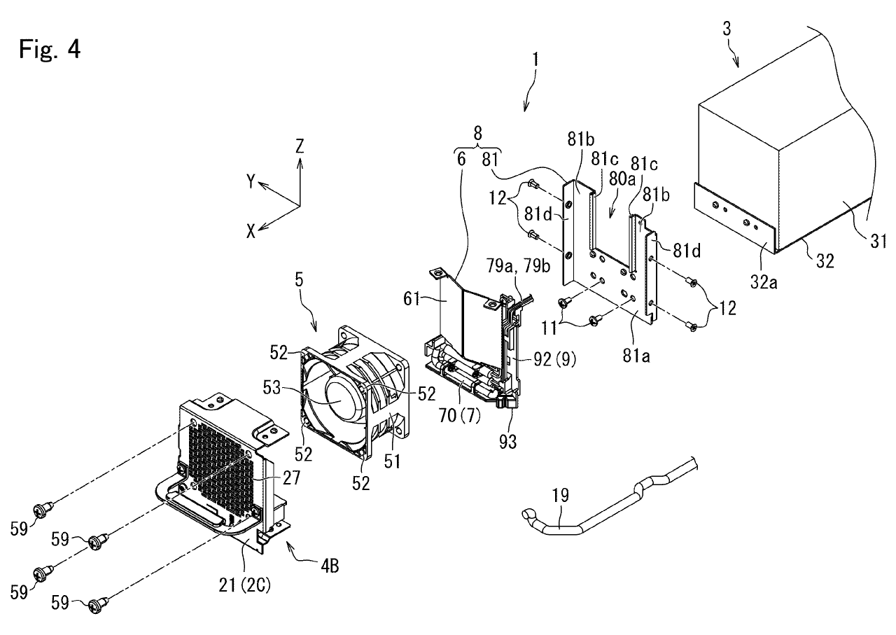

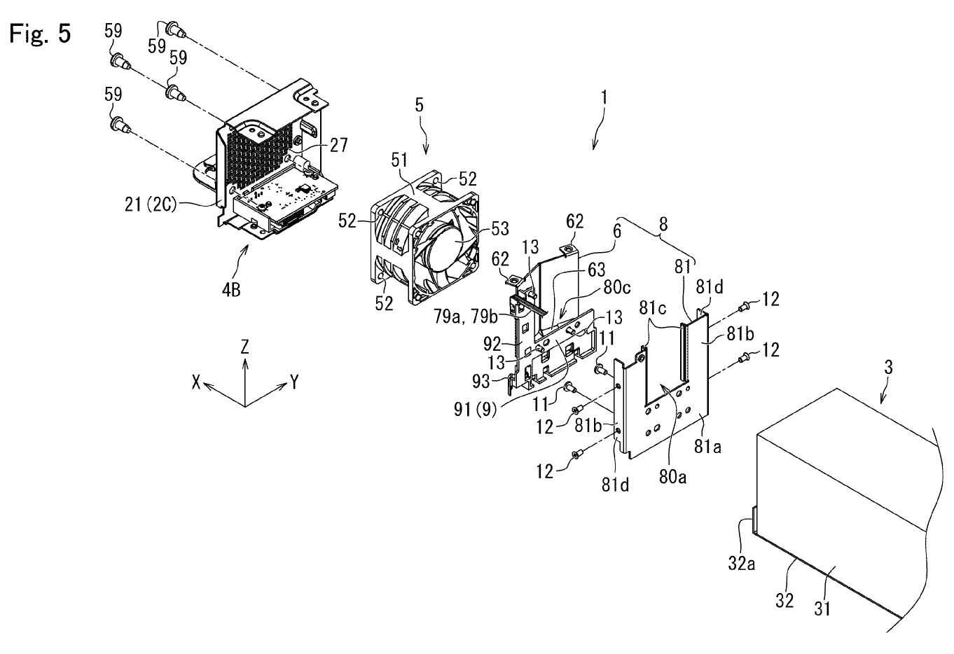

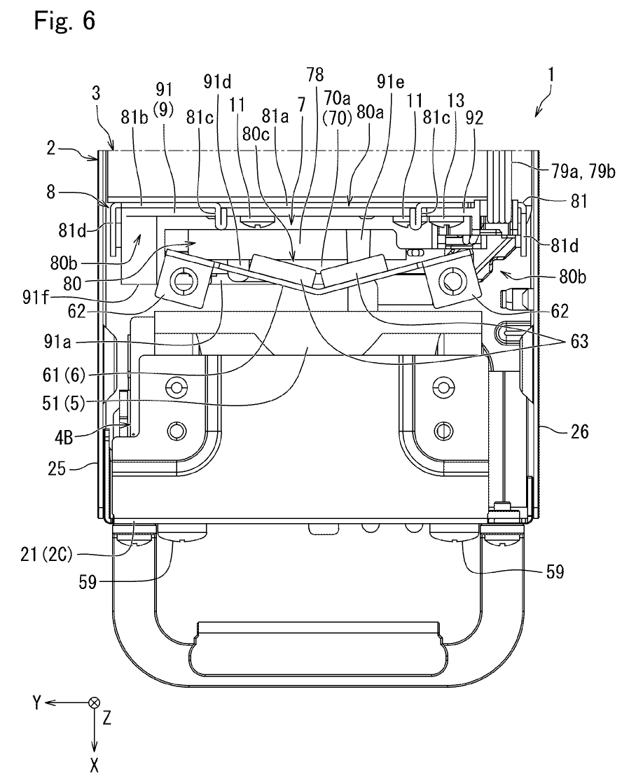

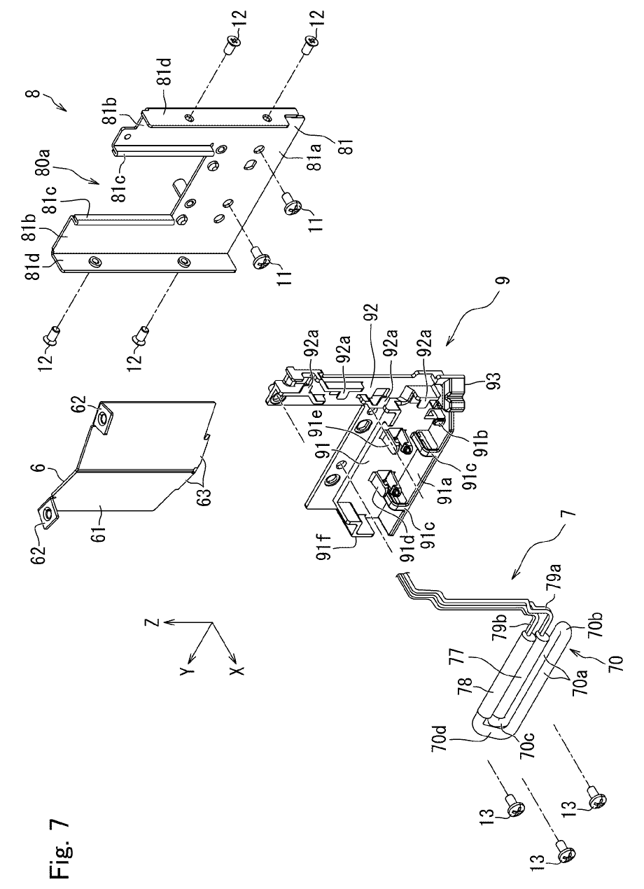

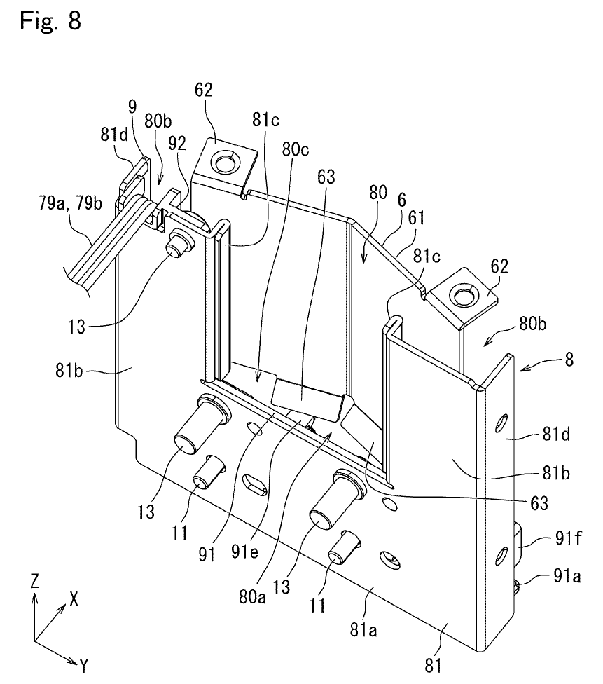

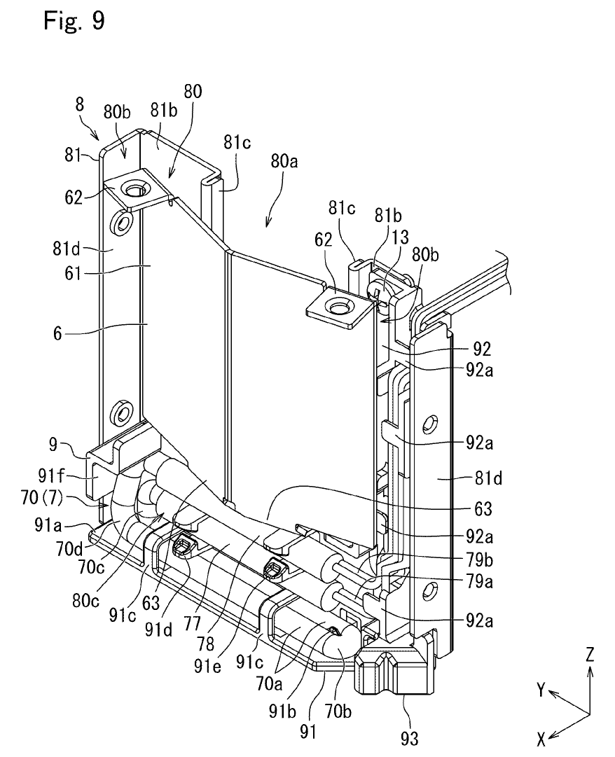

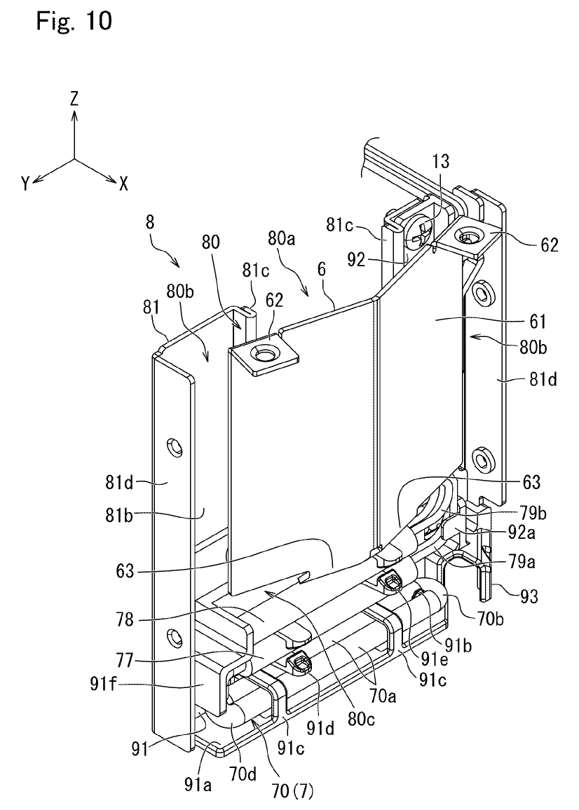

In order to maintain or improve detection accuracy of liquid entry when the liquid leakage sensor 7 is disposed in front of the fan, the battery module 1 includes the upright wall portion 6. Hereinafter, the structure and arrangement of the upright wall portion 6, the liquid leakage sensor 7, the exhaust duct 8, and the sensor holder 9 will be further described with reference to FIGS. 4 to 10. In FIGS. 4 to 10, illustration of the cover 2B of the exterior case 2 is omitted.

The exhaust duct 8 is disposed close to one side in the longitudinal direction X of the battery assembly 3. The exhaust duct 8 forms an exhaust path 80 for guiding the gas released from the battery assembly 3.

In this regard, the battery cell 30 includes an exhaust valve (not shown) that opens in response to an increase in internal pressure. When the exhaust valve opens, gas is released from the interior of the battery cell 30 to the exterior, optionally with sparks. The battery assembly 3 includes a gas guiding structure (not shown) that guides gas released from the battery cells 30 in the longitudinal direction X along a top or bottom surface of the cell holder 31. Similarly to the current collection structure and the heat transfer structure described above, the gas guiding structure is also overlapped on the top surface or the bottom surface of the cell holder 31. A part of the gas is released from the battery assembly 3 to one side in the longitudinal direction X, passes through the exhaust path 80, and is released to the outside of the exterior case 2 through the inflow port 27.

The exhaust duct 8 includes the upright wall portion 6. The exhaust duct 8 further includes a back plate 81 positioned between the upright wall portion 6 and the battery assembly 3 in the longitudinal direction. The upright wall portion 6 and the back plate 81 are manufactured by press working of a sheet metal such as stainless steel, for example.

The back plate 81 has a U shape as viewed in the longitudinal direction X. The back plate 81 includes a lower portion 81a extending in the width direction Y on the lower side, and a pair of side portions 81b extending upward from both sides of the lower portion 81a in the width direction Y. The lower portion 81a and the pair of side portions 81b define a rectangular cutout. The cover 2B of the exterior case 2 covers the cutout from above to define the inlet 80a of the exhaust path 80.

The back plate 81 includes a pair of inner ribs 81c protruding from inner edges (that is, both edges of the inlet 80a in the width direction Y) of the pair of side portions 81b toward one side in the longitudinal direction X. The back plate 81 includes a pair of outer ribs 81d folded back to one side in the longitudinal direction X from outer side edges of the pair of side portions 81b. Both the inner rib 81c and the outer rib 81d have a rectangular shape that is long in the height direction Z and short in the longitudinal direction X when viewed in the width direction Y, and the outer rib 81d is longer than the inner rib 81c in the height direction Z and the longitudinal direction X.

The lower portion 81a is fastened to the turnover part 32a of the battery assembly 3 with a bolt 11. The pair of outer ribs 81d are respectively fastened to the first side wall 25 and the second side wall 26 by bolts 12.

The upright wall portion 6 is fastened to the cover 2B with rivets 15 (see FIGS. 1 and 3), and extends downward from the inner surface of the top wall 24. For convenience, FIG. 3 illustrates a state in which the upright wall portion 6 is disassembled from the cover 2B, and illustrates an arrangement relationship between the upright wall portion 6, the back plate 81, and the sensor holder 9 in an assembled state of the battery module 1.

The upright wall portion 6 has a flat plate shape extending in the width direction Y and the height direction Z. One of the surfaces of the upright wall portion 6 is an opposing surface 61 facing the fan 5, and the other surface is a back surface facing the battery assembly 3 and covering the back plate 81. A flange 62 into which a rivet 15 (see FIG. 3) is inserted is provided on an upper edge of the upright wall portion 6. The opposing surface 61 has a rectangular shape when viewed from one side in the longitudinal direction X.

The upright wall portion 6 has a V shape inclined so as to be spaced apart from the fan 5 from the center in the width direction Y toward both outer sides in plan view. The inner rib 81c approaches and faces the back surface of the upright wall portion 6 with a slight clearance in the longitudinal direction X. Both side edges of the upright wall portion 6 in the width direction Y are located inside with respect to the outer rib 81d in the width direction Y, and are located on the other side with respect to the end edge of the outer rib 81d in the longitudinal direction X. A clearance between both side edges of the upright wall portion 6 and the outer rib 81d serves as a lateral outlet 80b of the exhaust path 80.

When viewed from one side in the longitudinal direction X, the upright wall portion 6 completely covers the inlet 80a. In other words, the lower edge of the opposing surface 61 extends in the width direction Y below the lower edge of the inlet 80a. The lower edge of the opposing surface 61 is located above the bottom wall 23. The clearance between the lower edge of the opposing surface 61 and the bottom wall 23 serves as a lower outlet 80c of the exhaust path 80. The lower outlet 80c is provided below the opposing surface 61, and an upper edge of the lower outlet 80c (a lower edge of the opposing surface 61) is located below a lower edge of the inlet 80a.

The gas flows into the exhaust path 80 from the other side toward one side in the longitudinal direction X through the inlet 80a. The gas is guided by the inner rib 81c and collides with the back surface of the upright wall portion 6. A part of the gas changes its direction in the width direction Y, changes its direction again to one side in the longitudinal direction X at the lateral outlet 80b, and flows out from the exhaust path 80 (space on the battery assembly 3 side with respect to the upright wall portion 6). That is, the gas flows so as to draw an S shape when viewed from the height direction Z. Further, a part of the gas changes its direction downward, changes its direction again to one side in the longitudinal direction X at the lower outlet 80c, and flows out from the exhaust path 80. That is, the gas flows in an S shape when viewed from the width direction Y.

As described above, the exhaust path 80 has a labyrinth shape and guides the gas while meandering. The gas and the spark collide with the exhaust duct 8 in the course of passing through the exhaust path 80, and kinetic energy and thermal energy thereof are absorbed by the exhaust duct 8. Before the gas is released, the gas temperature is lowered and the spark disappears.

The liquid leakage sensor 7 is disposed below the opposing surface 61. In other words, the liquid leakage sensor 7 is disposed at the lower outlet 80c of the exhaust path 80.

The liquid leakage sensor 7 includes a long detection cord 70 having flexibility. Although not illustrated in detail, the detection cord 70 includes two electrode wires, an inner braid that surrounds each electrode wire, and an outer braid that collectively surrounds the two electrode wires wound by the inner braid. The outer braid and the inner braid are made of, for example, chemical fibers such as polyester and polyethylene, and when a liquid adheres to the outer surface of the detection cord 70, the liquid can reach the electrode wire. When the liquid short-circuits the two electrode wires, the liquid leakage sensor 7 detects adhesion of the liquid based on a change in resistance between the electrode wires.

Both ends of the detection cord 70 are connected to the signal wires 79a and 79b, respectively. The signal wire 79a is electrically and mechanically connected to the two electrode wires in the detection cord 70 by welding. The same applies to the signal wire 79b. The liquid leakage sensor 7 includes a first sleeve 77 that protects a connection portion between one-end portion of the detection cord 70 and the signal wire 79a, and a second sleeve 78 that protects a connection portion between the other-end portion of the detection cord 70 and the signal wire 79a. Both the first sleeve 77 and the second sleeve 78 have a cylindrical shape having a diameter larger than that of the detection cord 70, and are wound around corresponding connection portions.

The detection cord 70 includes a pair of lateral extension portions 70a, a turn portion 70b connecting the pair of lateral extension portions 70a, a first curved portion 70c connecting one lateral extension portion 70a to the first sleeve 77, and a second curved portion 70d connecting the other lateral extension portion 70a to the second sleeve 78.

The pair of lateral extension portions 70a extends in the width direction Y while being in contact with and adjacent to each other in the longitudinal direction X. The turn portion 70b is bent in a hairpin shape and connects the other-end portions in the width direction of the pair of lateral extension portions 70a. The turn portion 70b corresponds to a central portion of the entire long detection cord 70. Among the liquid leakage sensors 7, in particular, the pair of lateral extension portions 70a and the turn portion 70b are disposed below the opposing surface 61. The first sleeve 77 extends in the width direction Y above the pair of lateral extension portions 70a. The second sleeve 78 extends in the width direction Y above the first sleeve 77.

The first curved portion 70c extends upward from an end portion of the lateral extension portion 70a and is folded back to the other side in the width direction Y. The first curved portion 70c connects one-end portions in the width direction Y of the lateral extension portion 70a and the first sleeve 77 to each other. The second curved portion 70d extends upward from an end portion of the lateral extension portion 70a and is folded back to the other side in the width direction Y. The second curved portion 70d connects one-end portions in the width direction Y of the lateral extension portion 70a and the second sleeve 78 to each other.

The sensor holder 9 is disposed between the battery assembly 3 and the fan 5, and holds the liquid leakage sensor 7 in the position and posture as described above. The sensor holder 9 is, for example, a resin molded article, whereby a component integrally having the following complicated structure can be realized.

The sensor holder 9 is generally plate-shaped. In a state where the surface on the other side in the longitudinal direction X of the sensor holder 9 overlaps the surface on one side in the longitudinal direction X of the back plate 81, the sensor holder 9 is fastened to the back plate 81 with the bolt 13. The liquid leakage sensor 7 is disposed on a surface on one side in the longitudinal direction X of the sensor holder 9.

The sensor holder 9 has, for example, an L shape when viewed from one side in the longitudinal direction X. The sensor holder 9 includes a cord holding portion 91 extending in the width direction Y on the lower side, and a wiring holding portion 92 extending upward from the other side in the width direction Y of the cord holding portion 91. The cord holding portion 91 is positioned below the inlet 80a and overlaps the lower portion 81a of the back plate 81. The wiring holding portion 92 is located on the other side in the width direction Y with respect to the inlet 80a and overlaps the side portion 81b of the back plate 81.

The cord holding portion 91 holds the detection cord 70, the first sleeve 77, and the second sleeve 78 at fixed positions. The cord holding portion 91 is provided with a seating portion 91a, a positioning rib 91b, an outer surrounding portion 91c, a first clamp 91d, a second clamp 91e, and a pressing portion 91f.

The seating portion 91a protrudes in the longitudinal direction X from the lower edge of the cord holding portion 91 and extends in the width direction Y. The pair of lateral extension portions 70a is placed on the upper surface of the seating portion 91a. The positioning rib 91b has a plate shape protruding upward from the other-end portion in the width direction Y of the seating portion 91a, has a length in the width direction Y, and has a thickness in the longitudinal direction X. The detection cord 70 is assembled to the cord holding portion 91 such that the pair of lateral extension portions 70a sandwich the positioning rib 91b and the inner peripheral edge of the turn portion 70b abuts on the positioning rib 91b. As a result, the detection cord 70 is arranged widely over the entire width direction Y on the seating portion 91a. In addition, the liquid leakage sensor 7 can be easily assembled in such an arrangement.

The outer surrounding portion 91c protrudes from the cord holding portion 91 to one side in the longitudinal direction X, is then bent downward, and is connected to the distal end edge of the seating portion 91a. The outer surrounding portion 91c has an inverted L shape when viewed in the width direction Y, and the pair of lateral extension portions 70a is inserted therethrough. However, the width of the outer surrounding portion 91c is very narrow. Therefore, while the position and posture of the pair of lateral extension portions 70a are favorably restrained by the outer surrounding portion 91c, most of the pair of lateral extension portions 70a are exposed upward without being hidden by the outer surrounding portion 91c. In the present embodiment, two outer surrounding portions 91c are disposed apart from each other in the width direction Y.

Both the first clamp 91d and the second clamp 91e include a pair of upper and lower locking parts protruding from the cord holding portion 91 to one side in the longitudinal direction X. The first sleeve 77 is sandwiched between the locking parts of the first clamp 91d. The second sleeve 78 is sandwiched between the locking parts of the second clamp 91e. In order to prevent the sleeve from falling off, claws protruding so as to approach each other are provided at the tips of the pair of locking parts.

The first clamp 91d is disposed above the outer surrounding portion 91c. The second clamp 91e is disposed above the first clamp 91d. The first clamp 91d and the second clamp 91e are disposed apart from each other in the width direction Y, and the outer surface of the lower locking part of the second clamp 91e is located below the outer surface of the upper locking part of the first clamp 91d. With this arrangement, the vertical distance between the first sleeve 77 and the second sleeve 78 can be reduced as much as possible, and the liquid leakage sensor 7 can be disposed in a compact manner.

The first sleeve 77 is supported not only by the restraint by the first clamp 91d but also by the outer surfaces of the pair of outer surrounding portions 91c and the outer surface of the lower locking part of the second clamp 91e, and is stably held in a posture extending in the width direction Y. The second sleeve 78 is not only held by the second clamp 91e but also placed on the outer surface of the upper locking part of the first clamp 91d and stably held in a posture extending in the width direction Y. The pressing portion 91f protrudes in the longitudinal direction X from one end edge of the cord holding portion 91 in the width direction Y. The pressing portion 91f has an inverted L shape and holds the second curved portion 70d in a bent state. The pressing portion 91f contributes to horizontal holding of the second sleeve 78.

The wiring holding portion 92 holds the signal wires 79a and 79b at fixed positions. The signal wires 79a and 79b collectively extend in the height direction Z on the wiring holding portion 92. The signal wires 79a and 79b are connected to the first sleeve 77 and the second sleeve 78 at the lower end of the wiring holding portion 92, and extend from above the upper end of the wiring holding portion 92 to the other side in the longitudinal direction X.

The wiring holding portion 92 is provided with a plurality of wiring hooks 92a separated in the height direction Z. The wiring hook 92a protrudes from the wiring holding portion 92 to one side in the longitudinal direction X and is then bent in the width direction Y. The signal wires 79a and 79b are locked to the hook-shaped wiring hook 92a, and are stably held in a posture linearly extending in the height direction Z.

A cable 19 connecting the battery assembly 3 and the second circuit unit 4B may be provided in the battery module 1. A cable tunnel 93 through which such a cable 19 passes may be provided at an end portion and a lower end portion of the sensor holder 9 in the width direction. Since the cable 19 does no longer need to pass through the labyrinth-shaped exhaust path 80, the routing work is facilitated.

The seating portion 91a is supported by the inner surface of the bottom wall 23. The detection cord 70, the first sleeve 77, and the second sleeve 78 are disposed below the upright wall portion 6. The detection cord 70 is positioned below the lower end of the fan 5.

The pair of lateral extension portions 70a faces the second circuit unit 4B in the longitudinal direction X. One end edge in the longitudinal direction of the pair of lateral extension portions 70a is located on one side in the longitudinal direction X with respect to both the first sleeve 77 and the second sleeve 78. In the present embodiment, the end edges on one side in the longitudinal direction of the pair of lateral extension portions 70a are retracted to the other side in the longitudinal direction X with respect to the fan 5.

The lower end portion of the upright wall portion 6 is inclined so as to be spaced apart from the fan 5 (that is, in a direction toward the other side in the longitudinal direction X,) toward the lower side. The opposing surface 61 may be inclined in this manner. In the present embodiment, the opposing surface 61 is not inclined in the longitudinal direction X, and the upright wall portion 6 has a pair of tabs 63 protruding from the lower edge of the opposing surface 61. This tab 63 is inclined in the longitudinal direction X.

In the present embodiment, the opposing surface 61 has a V shape in plan view, the central portion in the width direction Y is close to the fan 5, and both end portions in the width direction Y are away from the fan 5. On the other hand, the lateral extension portion 70a linearly extends in the width direction Y and is not inclined in the height direction Z or the longitudinal direction X. Both end portions of the opposing surface 61 are positioned directly above the pair of lateral extension portions 70a, whereas a central portion of the opposing surface 61 is positioned on one side in the longitudinal direction X with respect to the pair of lateral extension portions 70a. Therefore, the pair of tabs 63 is provided at the central portion of the opposing surface 61, and the lower end of the tab 63 is positioned directly above the pair of lateral extension portions 70a. Accordingly, the lateral extension portion 70a overlaps the lower edge of the opposing surface 61 or the lower edge of the tab 63 in the vertical direction over the entire width direction Y.

The upright wall portion 6 can be manufactured by press working of a sheet metal. The opposing surface 61 is bent in a V shape. By disposing the pair of tabs 63 at intervals in the width center of the opposing surface 61, the tabs 63 inclined with respect to the opposing surface 61 can be easily formed. The tips of the pair of tabs 63 are brought close to each other in the width direction Y by bending. Therefore, even if the pair of tabs 63 are disposed at intervals, there is almost no region where the lateral extension portion 70a does not vertically overlap the lower edge of the opposing surface 61 or the lower edge of the tab 63.

In the battery module 1 configured as described above, when the fan 5 operates, air is blown out from the fan 5 and blown against the opposing surface 61 of the upright wall portion 6. The opposing surface 61 has a V shape inclined so as to be spaced apart from the fan 5 from the center in the width direction toward both outer sides in plan view. Therefore, the air smoothly flows to the other side in the longitudinal direction X along the opposing surface 61, and the heat generating components such as the battery assembly 3 and the first circuit unit 4A can be cooled.

At this time, there is a possibility that liquid is carried by the air flow formed by the fan 5 to enter the inside of the exterior case 2 from the outside of the exterior case 2 through the inflow port 27.

When the air volume of the fan 5 is large, the liquid suctioned into the fan 5 is strongly blown out together with air from the fan 5, strongly blown toward the opposing surface 61, and adheres as droplets onto the opposing surface 61. The droplets flow downward along the opposing surface 61 by their own weight while taking in the liquid adhering to the opposing surface 61 at the lower side and increasing the size thereof. The liquid leakage sensor 7 is disposed below the opposing surface 61 as described above. Therefore, the liquid leakage sensor 7 can favorably sense a droplet flowing down on the opposing surface 61.

The pair of lateral extension portions 70a, the first sleeve 77, and the second sleeve 78 are arranged side by side in the height direction Z. The pair of lateral extension portions 70a protrudes to one side in the longitudinal direction X with respect to the first sleeve 77 and the second sleeve 78. Therefore, even if the pair of lateral extension portions 70a is disposed below the first sleeve 77 and the second sleeve 78, adhesion of the droplets that have fallen from the opposing surface 61 to the pair of lateral extension portions 70a can be facilitated.

The lower end portion of the upright wall portion 6 is inclined so as to be spaced apart from the fan 5 toward the lower side. Therefore, the droplets on the opposing surface 61 flow away from the fan 5 along the inclination at the lower end of the upright wall portion 6 and fall from the tip of the inclination. Even if there is a distance between the liquid leakage sensor 7 and the fan 5, the liquid collected on the opposing surface 61 can be dropped onto the liquid leakage sensor 7. Even when it is difficult to bring the liquid leakage sensor 7 close to the fan 5 due to the presence of the second circuit unit 4B or the like, the detection accuracy of the liquid entry can be improved.

In the present embodiment, the opposing surface 61 has a V shape for guiding air, and the opposing surface 61 is offset from the liquid leakage sensor 7 to one side in the longitudinal direction X at the central portion in the width direction Y. In such a case, it is advantageous to provide the above inclination because both improvement of air cooling performance and improvement of detection accuracy of liquid entry can be achieved. In addition, by providing the tab 63 at the central portion in the width direction Y and inclining the tab 63, this effect of combined achievement is provided by a simple structure.

On the other hand, when the air volume of the fan 5 is small, the liquid suctioned into the fan 5 descends by its own weight while flying in the airflow direction. Therefore, there is a possibility that the liquid does not adhere to the opposing surface 61 as described above. However, the liquid leakage sensor 7 is disposed below the opposing surface 61. Furthermore, the liquid leakage sensor 7 is disposed below the fan 5. Therefore, the liquid blown out from the fan 5 can be directly blown to the liquid leakage sensor 7, and the entry of the liquid can be favorably sensed.

As described above, according to battery module 1 of the present exemplary embodiment, the entry of the liquid can be accurately detected regardless of the air volume of the fan.

The exhaust duct 8 has the above-described upright wall portion 6. The exhaust duct 8 is a member for forming the exhaust path 80 for guiding the gas released from the battery assembly 3. The exhaust duct 8 has, not only a function of guiding gas, but also a function of receiving liquid. This can reduce the number of components of the battery module 1 and make the peripheral structure of the liquid leakage sensor 7 compact. In particular, the liquid leakage sensor 7 is disposed using the lower outlet 80c of the exhaust path 80, in other words, an opening portion forming the labyrinth-shaped exhaust path 80. Compared to a case where a dedicated space for disposing the liquid leakage sensor 7 is secured, the peripheral structure of the liquid leakage sensor 7 is compact.

The battery module 1 includes a sensor holder 9 that is disposed between the battery assembly 3 and the fan 5 and holds the liquid leakage sensor 7. Providing a dedicated component for holding facilitates positioning and assembly of the liquid leakage sensor 7. When the exhaust duct 8 has the upright wall portion 6 and the liquid leakage sensor 7 is disposed at the lower outlet 80c, at least a part of the member holding the liquid leakage sensor 7 is accommodated in the exhaust path 80. The exhaust duct 8 can be manufactured using a material and a structure necessary for heat resistance and gas guidance, and the sensor holder 9 can be manufactured using a material and a structure necessary for holding the liquid leakage sensor 7.

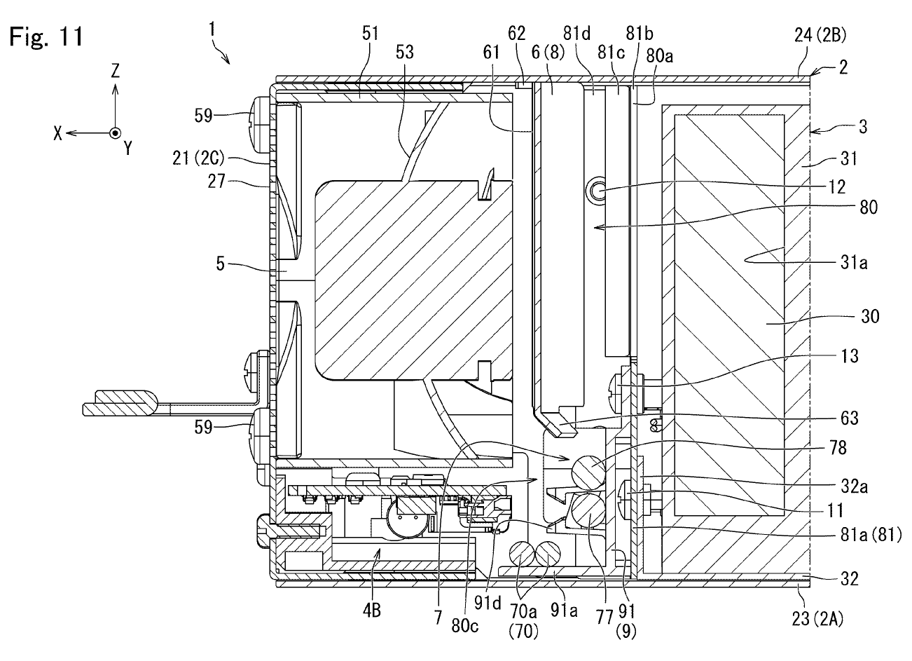

Next, with reference to FIG. 11, a battery module 1 according to a second embodiment will be described focusing on differences from the first embodiment.

As illustrated in FIG. 11, in the present embodiment, the end edge of the lateral extension portion of the liquid leakage sensor 7 is located on one side in the longitudinal direction X with respect to the fan front surface (the end surface on the other side in the longitudinal direction X of the fan 5). When the air volume of the fan 5 is small, a part of the liquid may fall downward from the lower edge of the fan front surface without flying from the fan 5. In the present embodiment, it is made possible to cause the droplets directly falling from the fan 5 as described above to adhere to the liquid leakage sensor 7. Therefore, the detection accuracy of the liquid entry is improved.

Of the pair of lateral extension portions, the lateral extension portion on the other side in the longitudinal direction X retracts toward the other side in the longitudinal direction X with respect to the fan front surface. In this case, the droplet flying while falling from the fan 5 by its own weight can be captured by the lateral extension portion on the other side.

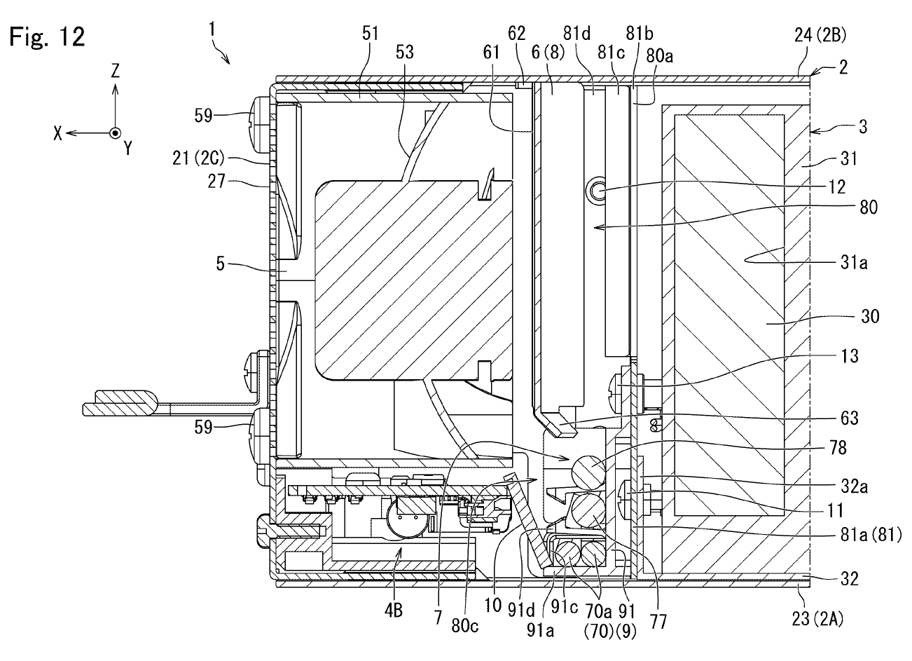

Next, with reference to FIG. 12, a battery module 1 according to a third embodiment will be described focusing on differences from the first embodiment.

As shown in FIG. 12, in the present embodiment, the battery module 1 includes a guide plate 10 extending from the lower edge of the fan front surface toward the fore end edge of the seating portion. In this case, it is possible to guide the droplets accumulated at the lower edge of the fan front surface along the guide plate 10 and to adhere to the lateral extension portion. Similarly to the second embodiment, the detection accuracy of liquid entry when the air volume of the fan 5 is small is improved.

Although the embodiment has been described so far, the above configuration is merely an example, and can be appropriately changed within the scope of the present disclosure.

The present disclosure may involve the following aspects.

Aspect 1

A battery module comprising:

an exterior case;

a battery assembly accommodated in the exterior case;

an inflow port provided in an end wall of the exterior case;

a fan that is attached to an inner surface of the end wall and blows air suctioned through the inflow port to an inside of the exterior case;

an upright wall portion that is disposed between the battery assembly and the fan, and has an opposing surface facing the fan; and

a liquid leakage sensor disposed below the opposing surface.

Aspect 2

The battery module according to Aspect 1, wherein the liquid leakage sensor is disposed below the fan.

Aspect 3

The battery module according to Aspect 1 or 2, wherein a lower end portion of the upright wall portion is inclined so as to be spaced apart from the fan toward the lower side.

Aspect 4

The battery module according to any one of Aspects 1 to 3, wherein the upright wall portion has a V shape inclined so as to be spaced apart from the fan from the center in the width direction toward both outer sides in a plan view.

Aspect 5

The battery module according to any one of Aspects 1 to 4, further comprising an exhaust duct forming an exhaust path for guiding a gas released from the battery assembly,

wherein the exhaust duct includes the upright wall portion.

Aspect 6

The battery module according to Aspect 5, wherein

the exhaust path guides the gas from a space on the battery assembly side with respect to the upright wall portion to a space on the fan side with respect to the upright wall portion through an outlet below a lower edge of the upright wall portion while meandering, and

the liquid leakage sensor is disposed at the outlet.

Aspect 7

The battery module according to any one of Aspects 1 to 6, further comprising a sensor holder that is disposed between the battery assembly and the fan and holds the liquid leakage sensor.

What is claimed is:

1. A battery module comprising:
an exterior case;
a battery assembly accommodated in the exterior case;
an inflow port provided in an end wall of the exterior case;
a fan that is attached to an inner surface of the end wall and blows air suctioned through the inflow port to an inside of the exterior case;
an upright wall portion that is disposed between the battery assembly and the fan, and has an opposing surface facing the fan; and
a liquid leakage sensor disposed below the opposing surface.

2. The battery module according to claim 1, wherein the liquid leakage sensor is disposed below the fan.

3. The battery module according to claim 1, wherein a lower end portion of the upright wall portion is inclined so as to be spaced apart from the fan toward the lower side.

4. The battery module according to claim 1, wherein the upright wall portion has a V shape inclined so as to be spaced apart from the fan from the center in the width direction toward both outer sides in a plan view.

5. The battery module according to claim 1, further comprising an exhaust duct forming an exhaust path for guiding a gas released from the battery assembly,
wherein the exhaust duct includes the upright wall portion.

6. The battery module according to claim 5, wherein
the exhaust path guides the gas from a space on the battery assembly side with respect to the upright wall portion to a space on the fan side with respect to the upright wall portion through an outlet below a lower edge of the upright wall portion while meandering, and
the liquid leakage sensor is disposed at the outlet.

7. The battery module according to claim 1, further comprising a sensor holder that is disposed between the battery assembly and the fan and holds the liquid leakage sensor.
